(19) United States
(12) Patent Application Publication
(10) Pub. No.: US 2008/0074624 A1
(43) Pub. Date: Mar. 27, 2008

(54) OPTICAL PROJECTION APPARATUS AND TOTAL INTERNAL REFLECTION PRISM THEREOF

(75) Inventors: Chin-Ku Liu, Hsinchu (TW); Sze-Ke Wang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CORETRONIC CORPORATION, Hsinchu (TW)

(21) Appl. No.: 11/836,145

(22) Filed: Aug. 9, 2007

(30) Foreign Application Priority Data
Sep. 22, 2006 (TW) 95135062

(51) Int. Cl. G03B 21/28; G02B 5/04

(52) U.S. Cl. 353/81; 359/833

(57) ABSTRACT

A total internal reflection prism of a projection apparatus including a first prism, a second prism and a total-reflection-inhibiting layer is provided. The first prism has a first surface, a second surface and a third surface. The second prism has a light incident surface and a light-emitting surface opposite to the first surface. A gap exists between the first surface and the light-emitting surface. The total-reflection-inhibiting layer is connected between a part of the light-emitting surface and a part of the first surface. By setting the total-reflection-inhibiting layer, the probability of total reflection of an illumination beam transmitted inside the total internal reflection prism is reduced. Therefore, the efficiency of utilizing the illumination beam is increased and the brightness of an image is promoted.

### CROSS-REFERENCE TO RELATED APPLICATION

This application claims the priority benefit of Taiwan application serial no. 95135062, filed Sep. 22, 2006. All disclosure of the Taiwan application is incorporated herein by reference.

### BACKGROUND OF THE INVENTION

1. Field of the Invention

The present invention relates to a display apparatus, and more particularly to a projection apparatus and a total internal reflection (TIR) prism thereof.

2. Description of Related Art

As shown in FIG. 1, a conventional projection apparatus 50 has an illumination system 52, a TIR prism 100, a digital micro-mirror device (DMD) 54 and a projection lens 56. The TIR prism 100 is composed of a first prism 110 and a second prism 120. The first prism 110 is a triangular prism having a first surface 112, a second surface 114 and a third surface 116 connected together to form a triangle. The second prism 120 is an optical path compensation prism having an incident surface 122 and a light-emitting surface 124, and the light-emitting surface 124 is opposite to the first surface 112, and an air gap exists between the light-emitting surface 124 and the first surface 112. In addition, the DMD 54 is disposed by the side of the second surface 114, the projection lens 56 is disposed by the side of the third surface 116, and the illumination system 52 is disposed by the side of the light incident surface 122.

An illumination beam 102 provided by the illumination system 52 enters the second prism 120 through the incident surface 122 and emerges from the light-emitting surface 124 into the air gap. After passing through the air gap, the illumination beam 102 passes through the first surface 112 and gets incident into the first prism 110. Next, the illumination beam 102 emerges from the second surface 114 of the first prism 110 and projects on the DMD 54. The DMD 54 transforms the illumination beam 102 into an image beam 104 and reflects the image beam 104 into the first prism 110 via the second surface 114. After producing total reflection on the first surface 102, the image beam 104 emerges from the third surface 116 of the first prism 110 toward the projection lens 56. The projection lens 56 projects the image beam 104 on a screen (not shown) to form an image. The second prism 120 is used for compensating the optical path difference of the illumination beam 102 and the image beam 104 caused by being transmitted in the first prism 110.

In the conventional technique, the air gap exists between the light-emitting surface 124 and the first surface 112 so that total reflection occurs when the image beam 104 is transmitted to the first surface 112. However, the refractive index of the second prism 120 is about 1.8, which is much greater than the refractive index of air. Therefore, when the illumination beam 102 is transmitted to the light-emitting surface 124, a part of the illumination beam 102 is totally reflected (as shown by the beam 103) due to a large incident angle and hence the illumination beam 102 is not effectively utilized. Consequently, the brightness of the image on the screen is lowered.

### SUMMARY OF THE INVENTION

Accordingly, at least one objective of the present invention is to provide a projection apparatus and a total internal reflection (TIR) prism thereof that reduces the probability of total reflection of an illumination beam transmitted inside the TIR prism and promotes the brightness of the image.

At least one objective of the present invention is to provide a projection apparatus and a TIR prism thereof that reduces the probability of total reflection of stray lights, transmitted inside a first prism, occurred on a first surface of the first prism. Hence, the stray lights are emitted from the first surface and prevent the stray lights from adversely affecting the contrast of the image.

To achieve these and other advantages and in accordance with the purpose of the invention, as embodied and broadly described herein, the invention provides a projection apparatus comprising a total internal reflection (TIR) prism, an illumination system, a reflective light valve and a projection lens. The TIR prism comprises a first prism, a second prism and a total-reflection-inhibiting layer. The first prism has a first surface, a second surface and a third surface. The second prism has a light incident surface and a light-emitting surface opposite to the first surface. A gap exists between the first surface and the light-emitting surface. The total-reflection-inhibiting layer is connected between a part of the light-emitting surface and a part of the first surface. In addition, the illumination system is disposed by the side of the light incident surface and is suitable for providing an illumination beam toward the light incident surface. The reflective light valve is disposed by the side of the second surface and is located on a transmission path of the illumination beam. The reflective light valve is suitable for converting the illumination beam into an image beam. The projection lens is disposed by the side of the third surface and located on a transmission path of the image beam.

The present invention also provides a TIR prism of the foregoing description.

The present invention also provides a projection apparatus comprising a TIR prism, an illumination system, a reflective light valve and a projection lens. The TIR prism includes a first prism and a second prism. The first prism has a first surface, a second surface and a third surface. The second prism has a light incident surface and a light-emitting surface. A part of the light incident surface and a part of the first surface are connected, and a gap exists between the remaining part of the light-emitting surface and the remaining part of the first surface. In addition, the illumination system is disposed by the side of the light incident surface and is suitable for providing an illumination beam toward the light incident surface. The reflective light valve is disposed by the side of the second surface and located on a transmission path of the illumination beam. The reflective light valve is suitable for converting the illumination beam into an image beam. The projection lens is disposed by the side of the third surface and located on a transmission path of the image beam.

Because of the total-reflection-inhibiting layer between the first prism and the second prism in the TIR prism or the part connection between the first prism and the second prism in the TIR prism in the present invention, the probability of total reflection of the illumination beam is effectively reduced. Therefore, the projection apparatus of the present invention can promote the brightness of an image.

Other objectives, features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF THE DRAWINGS

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a conventional projection apparatus.

FIG. 2A is a schematic diagram of a projection apparatus according to an embodiment of the present invention.

FIG. 2B is a diagram showing an illumination area and an image area of a first surface in FIG. 2A.

FIG. 3A is a schematic diagram of a projection apparatus according to another embodiment of the present invention.

FIG. 3B is a diagram showing an illumination area and an image area of a first surface in FIG. 3A.

FIG. 4 is a diagram showing a TIR prism according to still another embodiment of the present invention.

FIG. 5A is a diagram showing a TIR prism according to yet another embodiment of the present invention.

FIG. 5B is a diagram showing an illumination area and an image area of a first surface in FIG. 5A.

### DESCRIPTION OF THE PREFERRED EMBODIMENTS

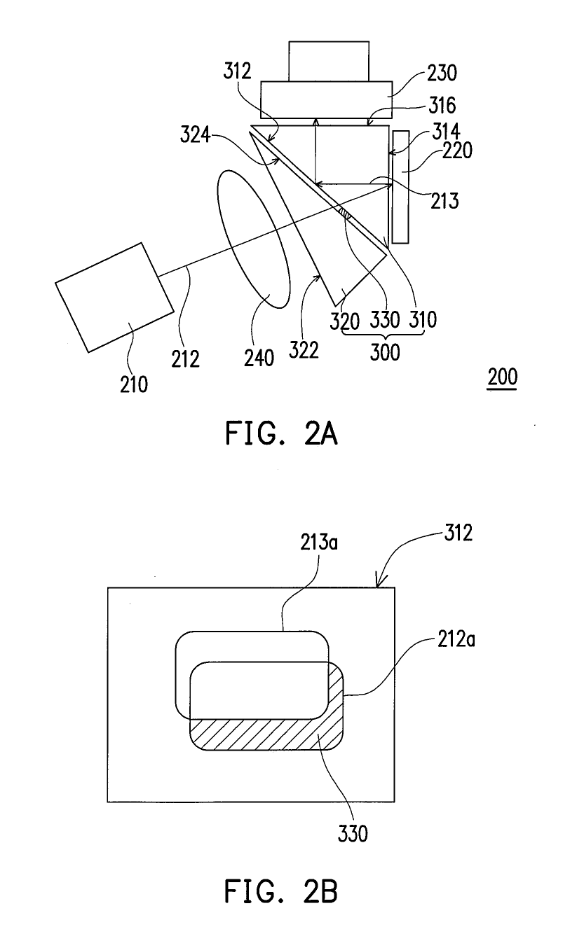

As shown in FIG. 2A, a projection apparatus 200 in the present embodiment includes a total internal reflection (TIR) prism 300, an illumination system 210, a reflective light valve 220 and a projection lens 230. The TIR prism 300 includes a first prism 310, a second prism 320 and a total-reflection-inhibiting layer 330. The first prism 310 is, for example, a triangular prism having a first surface 312, a second surface 314 and a third surface 316 connected to form a triangle, and the first surface 312, the second surface 314 and the third surface 316 are flat surfaces, for example. The second prism 320 is an optical path compensation prism for compensating the optical path difference of a light beam transmitted inside the first prism 310. The second prism 320 has a light incident surface 322 and a light-emitting surface 324, and the light-emitting surface 324 is opposite to the first surface 312. Furthermore, a gap exists between the light-emitting surface 324 and the first surface 312, and the gap is an air gap, for example.

The illumination system 210 is disposed by the side of the light incident surface 322. The illumination system 210 includes a lens 240 and is suitable for providing an illumination beam 212 to the light incident surface 322. The lens 240 focuses the illumination beam 212 on the reflective light valve 220. The reflective light valve 220 can be a DMD or a liquid crystal on silicon (LCOS) panel. The reflective light valve 220 is disposed by the side of the second surface 314 along the transmission path of the illumination beam 212. The reflective light valve 220 is suitable for converting the illumination beam 212 into an image beam 213. The projection lens 230 is disposed by the side of the third surface 316 along the transmission path of the image beam 213. The illumination beam 212 sequentially passes through the light incident surface 322, the light-emitting surface 324, the first surface 312 and the second surface 314. Afterwards, the illumination beam 212 projects on the reflective light valve 220 and then the image beam 213 reflected from the reflective light valve 220 is transmitted to the first surface 312 via the second surface 314. After total reflection from the first surface 312, the image beam 213 emerges from the third surface 312 to the projection lens 230. Finally, the image beam 213 is projected through the projection lens 230 to a screen (not shown) to form an image.

As shown in FIGS. 2A and 2B, the total-reflection-inhibiting layer 330 is connected to a part of the light-emitting surface 324 and a part of the first surface 312. In the present embodiment, the light-emitting surface 324 and the first surface 312 respectively have an illumination area 212a illuminated by the illumination beam 212. The first surface 312 has an image area 213a illuminated by the image beam 213. One side of the total-reflection-inhibiting layer 330 is connected to a part of the illumination area 212a (the line-filled region in FIG. 2B) of the first surface 312 not overlapping the image area 213a. Another side of the total-reflection-inhibiting layer 330 is connected to a part of the light-emitting surface 324 opposite to the part of the illumination area 212a of the light-emitting surface 324 not overlapping the image area 213a. When the illumination beam 212 is transmitted to the light-emitting surface 324, the probability of total reflection of the illumination beam 212 is reduced due to the setting of the total-reflection inhibiting layer 330 on part of the illumination area 212 of the light-emitting surface 324. As a result, the efficiency of utilizing the illumination beam 212 is increased and the brightness of image is promoted. Moreover, the image beam 213 does not illuminate the area on the first surface 312 where the total-reflection-inhibiting layer 330 is disposed. Hence, the efficiency of total reflection of the image beam 213 from the first surface 312 is unaffected.

In the present embodiment, the total-reflection-inhibiting layer 330 may be fabricated by optical adhesive or a material similar to the lens. In addition, the refractive index of the total-reflection-inhibiting layer 330 may be adjusted according to the refractive indexes of the first prism 310 and the second prism 320 so that the probability of total reflection of the illumination beam 212 on the light-emitting surface 324 is further reduced. More specifically, if the refractive index of the first prism 310 is n1, the refractive index of the second prism 320 is n2, the refractive index of the total-reflection-inhibiting layer 330 is n3 and the refractive index of air is n4, then the constraints in the present embodiment may include n3>n4, |n1-n4|>n1-n3| or |n2-n4|>|n2-n3|.

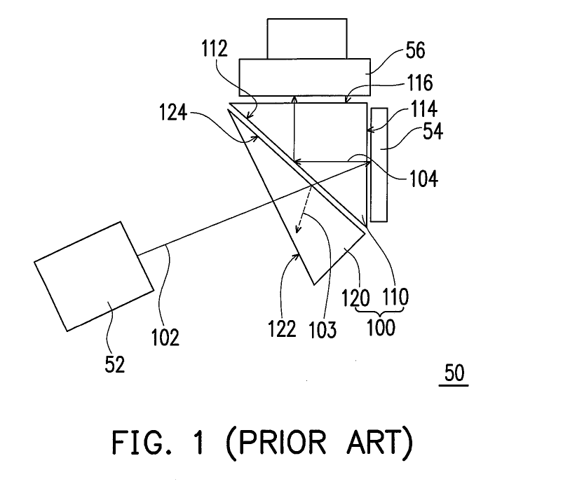

To compare the projection apparatus 200 of the present embodiment with the projection apparatus (as shown in FIG. 1) of the convention technique, assume that the refractive indexes of both the first prism 110 in the conventional technique and the first prism 310 in the present embodiment are 1.6096, the refractive indexes of both the second prism 120 in the conventional technique and the second prism 320 in the present embodiment are 1.5354, and the refractive index of the total-reflection-inhibiting layer 330 of the present embodiment is 1.5185. A simulation using the ASAP simulation software shows that the flux of the screen image projected by the conventional projection is 67.1325 while the flux of the screen image projected by the projection apparatus 200 in the present embodiment is 72.5392. Therefore, the present embodiment is capable of increasing the brightness of image relative to the conventional technique by 8%.

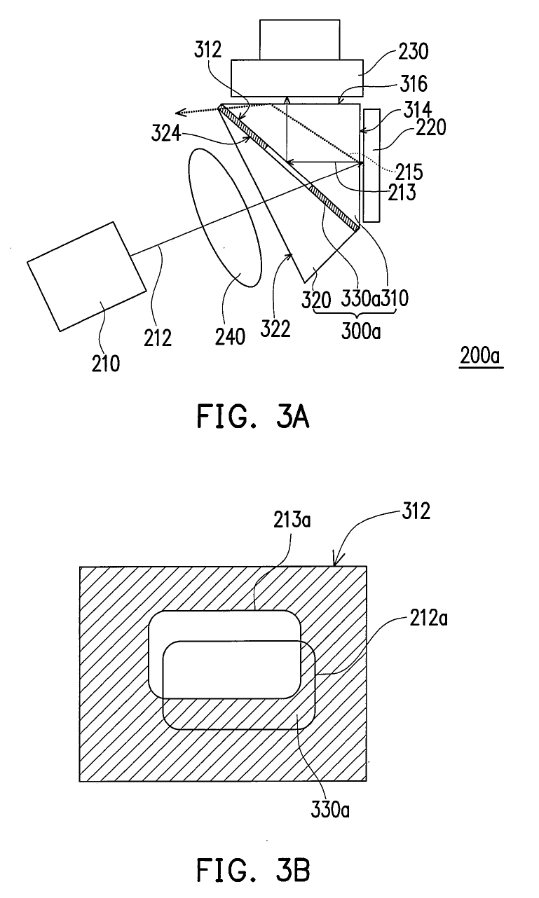

As shown in FIGS. 3A and 3B, a projection apparatus 200a in the present embodiment is similar to the projection apparatus 200 in FIG. 2A except for the total-reflection-inhibiting layer 330a of the TIR prism 300a. In the present embodiment, one side of the total-reflection-inhibiting layer 330a of the TIR prism 300a is connected to an area (the line-filled area of FIG. 3B) on the first surface 312 not illuminated by the image beam 213. The other side of the total-reflection-inhibiting layer 330a is connected to an area of the light-emitting surface 324 opposite to the area of the first surface 312 not illuminated by the image beam 213. Consequently, besides reducing the probability of total reflection of the illumination beam 212, the probability of total reflection of stray lights in the first prism 310 by the first surface 312 is also reduced. Hence, the stray lights emerge from the first surface 312, thereby preventing the stray lights from transmitting to the projection lens 230 to affect the contrast of the image. In addition, when the reflective light valve 220 is a DMD, the foregoing stray lights include a light beam 215 reflected from the mirrors of the DMD in the off state.

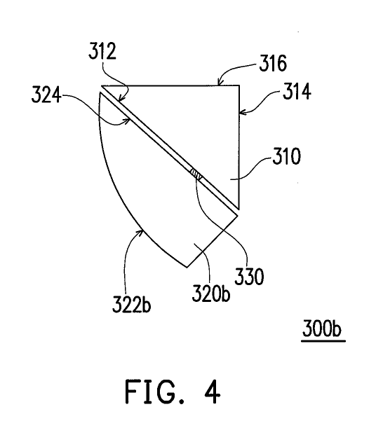

As shown in FIG. 4, the TIR prism 300b in the present embodiment is similar to the TIR prism 300 in FIG. 2A. The difference is that while the light incident surface 322 of the second prism 320 of the TIR prism 300 is a plane surface, the light incident surface 322b of the second prism 320b of the TIR prism 300b is a curved surface. Because a curved surface has some focusing effect, there is no need to set up a focusing lens 240 when the TIR prism 300b is applied to the projection apparatus 200. In other words, the cost of the lens 240 is saved. In addition, the light incident surface 322 of the second prism 320 in FIG. 3A can be a curved surface as well.

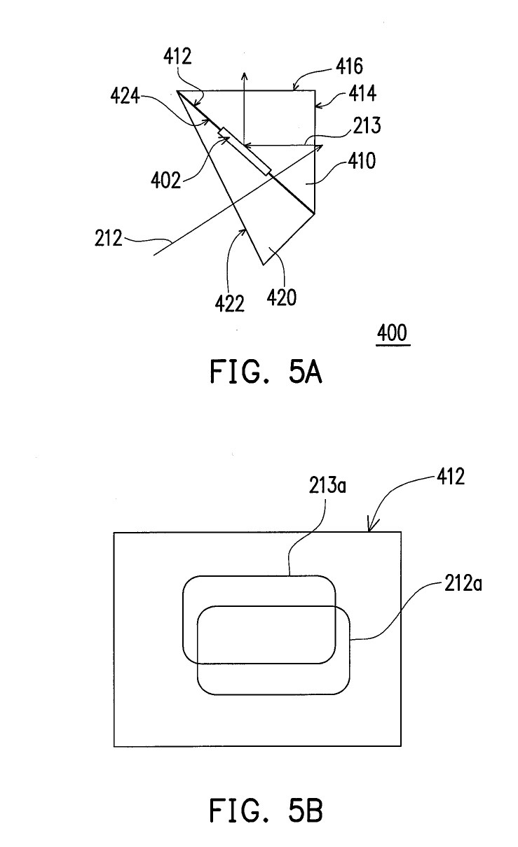

As shown in FIGS. 5A and 5B, a TIR prism 400 in the present embodiment includes a first prism 410 and a second prism 420. The first prism 410 has a first surface 412, a second surface 414 and a third surface 416. The second prism 420 has a light incident surface 422 and a light-emitting surface 424. A part of the light-emitting surface 424 and a part of the first surface 412 are connected. A gap 402 exists between the remaining part of the light-emitting surface 424 and the remaining part of the first surface 412 and the medium inside the gap 402 is air, for example. When the TIR prism 400 is applied to a projection apparatus, the gap 402 is located between the area (the image area 213a) of the first surface 412 illuminated by the image beam 213 and the area of the light-emitting surface 424 opposite to the area of the first surface 412 illuminated by the image beam 213. By setting up the gap 402, the image beam 213 transmitted to the first surface 412 is totally reflected so that the image beam 5 213 emerges from the third surface 416. In addition, the setting of the area where the first surface 412 and the light-emitting surface 424 are connected reduces the probability of total reflection when the illumination beam 212 is transmitted to the light-emitting surface 424, and the brightness of image is promoted. Furthermore, the probability of total reflection of stray lights in the first prism 410 by the first surface 412 is reduced so that the stray lights is able to emit from the first surface 412 and prevent the stray lights from adversely affecting the contrast of image.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection apparatus, comprising:
a total internal reflection prism, comprising:
a first prism, having a first surface, a second surface and a third surface;
a second prism, having a light incident surface and a light-emitting surface, the light-emitting surface being opposite to the first surface, and a gap existing between the light-emitting surface and the first surface; and
a total-reflection-inhibiting layer, connected between a part of the light-emitting surface and a part of the first surface;
an illumination system, disposed by the side of the light incident surface for providing an illumination beam to the light incident surface;
a reflective light valve, disposed by the side of the second surface and located on a transmission path of the illumination beam, the reflective light valve being suitable for converting the illumination beam into an image beam; and
a projection lens, disposed by the side of the third surface and located on a transmission path of the image beam.

2. The projection apparatus of claim 1, wherein the light-emitting surface and the first surface respectively have an illumination area illuminated by the illumination beam, the first surface further has an image area illuminated by the image beam, one side of the total-reflection-inhibiting layer is connected to a part of the illumination area of the first surface that does not overlap the image area and the other side of the total-reflection-inhibiting layer is connected to a part of the light-emitting surface opposite to the part of the illumination area of the light-emitting surface that does not overlap the image area.

3. The projection apparatus of claim 1, wherein a refractive index of the first prism is n1, a refractive index of the total-reflection-inhibiting layer is n3 and a refractive index of air is n4, and |n1-n4|>|n1-n3|.

4. The projection apparatus of claim 1, wherein a refractive index of the second prism is n2, a refractive index of the total-reflection-inhibiting layer is n3 and a refractive index of air is n4, and |n2-n4|>|n2-n3|.

5. The projection apparatus of claim 1, wherein a refractive index of the total-reflection-inhibiting layer is greater than a refractive index of air.

6. The projection apparatus of claim 1, wherein the total-reflection-inhibiting layer comprises an optical adhesive.

7. The projection apparatus of claim 1, wherein the light incident surface comprises a curved surface.

8. The projection apparatus of claim 1, wherein one side of the total-reflection-inhibiting layer is connected to an area of the first surface not illuminated by the image beam and another side of the total-reflection-inhibiting layer is connected to an area of the light-emitting surface opposite to the area of the first surface not illuminated by the image beam.

9. The projection apparatus of claim 1, wherein the illumination beam sequentially passes through the light incident surface, the light-emitting surface, the first surface and the second surface and is incident upon the reflective light valve, then the image beam is transmitted to the first surface via the second surface and emerges from the third surface to the projection lens after being reflected by the first surface.

10. A total internal reflection prism, comprising:
a first prism, having a first surface, a second surface and a third surface;
a second prism, having a light incident surface and a light-emitting surface, the light-emitting surface being opposite to the first surface and a gap existing between the light-emitting surface and the first surface; and
a total-reflection-inhibiting layer, connected to a part of the light-emitting surface and a part of the first surface.

11. The total internal reflection prism of claim 10, wherein the light-emitting surface and the first surface respectively have an illumination area illuminated by an illumination beam, the first surface has an image area illuminated by an image beam, one side of the total-reflection-inhibiting layer is connected to a part of the illumination area of the first surface that does not overlap the image area and the other side of the total-reflection-inhibiting layer is connected to a part of the light-emitting surface opposite to the part of the illumination area of the light-emitting surface that does not overlap the image area.

12. The total internal reflection prism of claim 10, wherein a refractive index of the first prism is n1, a refractive index of the total-reflection-inhibiting layer is n3 and a refractive index of air is n4, and |n1-n4|>|n1-n3|.

13. The total internal reflection prism of claim 10, wherein a refractive index of the second prism is n2, a refractive index of the total-reflection-inhibiting layer is n3 and a refractive index of air is n4, and |n2-n4|>|n2-n3|.

14. The total internal reflection prism of claim 10, wherein a refractive index of the total-reflection-inhibiting layer is greater than a refractive index of air.

15. The total internal reflection prism of claim 10, wherein the total-reflection-inhibiting layer comprises an optical adhesive.

16. The total internal reflection prism of claim 10, wherein one side of the total-reflection-inhibiting layer is connected to an area of the first surface not illuminated by the image beam and the other side of the total-reflection-inhibiting layer is connected to an area of the light-emitting surface opposite to the area of the first surface not illuminated by the image beam.

17. A projection apparatus, comprising:
a total internal reflection prism, comprising:
a first prism, having a first surface, a second surface and a third surface; and
a second prism, having a light incident surface and a light-emitting surface, a part of the light-emitting surface and a part of the first surface being connected and a gap existing between the remaining part of the light-emitting surface and the remaining part of the first surface;
an illumination system, disposed by the side of the light incident surface for providing an illumination beam to the light incident surface;
a reflective light valve, disposed by the side of the second surface and located on a transmission path of the illumination beam, the reflective light valve being suitable for converting the illumination beam into an image beam; and
a projection lens, disposed by the side of the third surface and located on a transmission path of the image beam.

18. The projection apparatus of claim 17, wherein the gap is located between an area of the first surface illuminated by the image beam and an area of the light-emitting surface opposite to the area of the first surface illuminated by the image beam.

19. A total internal reflection prism, comprising:
a first prism, having a first surface, a second surface and a third surface; and
a second prism, having a light incident surface and a light-emitting surface, a part of the light-emitting surface and a part of the first surface being connected and a gap existing between the remaining part of the light-emitting surface and the remaining part of the first surface.

20. The total internal reflection prism of claim 19, wherein the gap is located between an area of the first surface illuminated by an image beam and an area of the light-emitting surface opposite to the area of the first surface illuminated by the image beam.
